(19) United States
(12) Patent Application Publication
(10) Pub. No.: US 2006/0012580 A1
(43) Pub. Date: Jan. 19, 2006

(54) Automatic switching for a dual mode digitizer

(75) Inventors: Haim Perski, Hod Hasharon (IL); Ori Rimon, Tel-Aviv (IL)

Correspondence Address: Martin Moynihan;c/o ANTHONY CASTORINA, SUITE 207, 2001 JEFFERSON DAVIS HIGHWAY, ARLINGTON, VA, 22202, US

(73) Assignee: N-trig Ltd.

(21) Appl. No.: 11/180,686

(22) Filed: Jul. 14, 2005

Related U.S. Application Data
(60) Provisional application No. 60/587,665, filed on Jul. 15, 2004.
(60) Provisional application No. 60/642,152, filed on Jan. 10, 2005.

(51) Int. Cl. G09G 5/00

(52) U.S. Cl. 345/173

(57) ABSTRACT

An apparatus for detecting a plurality of user interactions, comprising: at least one detector for sensing the user interactions, a respective controller, associated with each of the detectors, for finding positions of the user interactions, and a switcher, associated with the controllers, for handling the user interactions, according to a defined policy.

### RELATED APPLICATIONS

The present application claims the benefit of U.S. Provisional Application No. 60/587,665, filed on Jul. 15, 2004, and U.S. Provisional Application No. 60/642,152, filed on Jan. 10, 2005, the contents of which are herein incorporated by reference.

### FIELD AND BACKGROUND OF THE INVENTION

The present invention relates to a digitizer, and more particularly, but not exclusively to a digitizer for inputting multiple user interactions to a computing device.

Touch technologies are commonly used as input devices for a variety of products. The usage of touch devices of various kinds is growing sharply due to the emergence of new mobile devices, such as Web-Pads, Web Tablets, Personal Digital Assists (PDA), Tablet PCs and wireless flat panel display (FPD) screen displays. These new devices are usually not connected to standard keyboards, mice or like input devices, which are deemed to limit their mobility. Instead there is a tendency to use touch input technologies of one kind or another.

Some of the new mobile devices, such as the Tablet PC, are powerful computer tools. Devices such as the Tablet PC use a stylus based input device, and use of the Tablet PC as a computing tool is dependent on the abilities of the stylus input device. The input devices have the accuracy to support hand writing recognition and full mouse emulation, for example hovering, right click, etc. Manufacturers and designers of these new mobile devices have determined that the stylus input system can be based on various electromagnetic technologies, which can satisfy the very high performance requirements of the computer tools in terms of resolution, fast update rate, and mouse functionality.

U.S. Pat. No. 6,690,156 entitled “Physical Object Location Apparatus and Method and a Platform using the same”, assigned to N-trig Ltd., the contents of which are hereby incorporated by reference, describes an electromagnetic method for locating physical objects on a flat screen display, that is to say, a digitizer that can be incorporated into the active display screen of an electronic device.

U.S. Pat. No. 6,690,156 entitled “Physical Object Location Apparatus and Method and a Platform using the same”, assigned to N-trig Ltd., introduces a device capable of detecting the location and identity of physical objects, such as a stylus, located on top of a display. The above electromagnetic technology enables the accurate position detection of one or more electromagnetic pointers, as well as the sensing of multiple physical objects, for example playing pieces for use in games.

U.S. Pat. No. 6,690,156, entitled “Physical Object Location Apparatus and Method and a Platform, using the same”, assigned to N-trig Ltd., and U.S. patent application Ser. No. 10/649,708 entitled “Transparent Digitizer”, filed for N-trig Ltd., describe a positioning device capable of detecting multiple physical objects, preferably styluses, located on top of a flat screen display. One of the preferred embodiments in both patents describes a system built of transparent foils containing a matrix of vertical and horizontal conductors. The stylus is energized by an excitation coil that surrounds the foils. The exact position of the stylus is determined by processing the signals that are sensed by the matrix of horizontal and vertical conductors.

U.S. patent application Ser. No. 10/757,489 entitled “Touch detection for a digitizer” assigned to N-trig, describes three methods of touch detection using the transparent sensor described in the above cited U.S. patent application Ser. No. 10/649,708.

However, none of the above mentioned applications provides a method or an apparatus for switching between different user interactions and appropriately utilizing different user interactions, for example, moving an electromagnetic stylus, moving another object, or touching a screen with a finger.

The problem is best explained when considering a user using a finger touch and an electromagnetic stylus for mouse emulation, while operating a computer program. When the user is touching the screen while placing the electromagnetic stylus close to the sensor, the digitizer recognizes two physical objects at the same time. To allow mouse emulation, a decision has to be made regarding the position of the computer cursor. The computer cursor can not be located at two places at the same time, nor should it hop from the stylus position to the finger position uncontrollably. The system has to select between the stylus and finger coordinates and move the cursor accordingly.

There is thus a widely recognized need for, and it would be highly advantageous to have, a digitizer system devoid of the above limitations.

### SUMMARY OF THE INVENTION

According to one aspect of the present invention there is provided an apparatus for detecting a plurality of user interactions, comprising: a detector for sensing the user interactions, a controller, associated with the sensor, for finding the position of the user interactions, and a switcher, associated with the controller, for handling the user interactions, according to a defined policy.

Preferably, the defined policy includes granting priority to a user interaction over other user interactions upon the performance of a dedicated user gesture.

The user interactions may include, for example, an interaction via an electromagnetic stylus or an interaction using touch.

According to a second aspect of the present invention, there is provided a system for detecting a plurality of user interactions, comprising: at least one digitizer, configured for detecting at least one user interaction and a switching module, associated with the at least one digitizer, for handling data relating to the at least one user interaction. The switching module may be implemented on a digitizer. The switching module may also be implemented on a switching unit, or on a host computer, associated with the digitizer(s).

According to a third aspect of the present invention, there is provided a method for detecting a plurality of user interactions, comprising: detecting positions relating to each of the user interactions, handling the positions in accordance with a defined policy, and providing data relating to the handling of the positions.

According to a fourth aspect of the present invention, there is provided an apparatus for gesture recognition, comprising: a detector for detecting at least one user interaction and a gesture recognizer, associated with the detector, and configured for determining if said user interaction is a predefined gesture.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram of an apparatus for detecting user interactions, according to a preferred embodiment of the present invention;

FIG. 2 is a block diagram of possible systems, in accordance with preferred embodiments of the present invention;

FIG. 3 is a flow diagram, illustrating a first state machine, for detection mode switching, according to a preferred embodiment of the present invention;

FIG. 4 is a flow diagram, illustrating a second state machine, for detection mode switching, according to a preferred embodiment of the present invention;

FIG. 5 is a flow diagram, illustrating a third state machine, for detection mode switching, according to a preferred embodiment of the present invention;

FIG. 6 is a block diagram, illustrating a first system for detection of user-interactions, according to a preferred embodiment of the present invention;

FIG. 7 is a block diagram, illustrating a second system for detection of user-interactions, according to a preferred embodiment of the present invention;

FIG. 8 is a block diagram, illustrating a third system for detection of user-interactions, according to a preferred embodiment of the present invention;

FIG. 9 is a block diagram of an apparatus for gesture recognition, according to a preferred embodiment of the present invention; and

FIG. 10 is a flow diagram, illustrating a method, for detection of user-interactions, according to a preferred embodiment of the present invention.

### DESCRIPTION OF THE PREFERRED EMBODIMENTS

The present embodiments comprise an apparatus, a method, and systems for detection of different user interactions, by switching between detection modes in respect to the different of user interaction.

The principles and operation of an apparatus, a method and systems, according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention is best explained by referring to the digitizer system described in the background section of this application, taught in U.S. Pat. No. 6,690,156, entitled “Physical Object Location Apparatus and Method and a Platform using the same”, assigned to N-trig Ltd., and U.S. patent application Ser. No. 10/649,708, entitled “Transparent Digitizer”, filed for N-trig Ltd., which are hereby incorporated by reference. However, the present invention can be implemented in any system that receives two or more user interactions. The user interactions may be, but are not limited to two specific kinds of interaction, those via touch and those via electromagnetic stylus. The present invention can be utilized in order to enable switching between two electromagnetic styluses, if for example each stylus has a unique characteristic that distinguishes its signals from the other electromagnetic styluses in the system.

The present embodiments attempt to improve the usability of a digitizer system capable of detecting multiple physical objects. The digitizer is in fact a computer associated detector, or input device capable of tracking user interactions. In most cases the digitizer is associated with a display screen to enable touch or stylus detection.

A digitizer may detect the position of at least one physical object in a preferably very high resolution and update rate. The physical object can be either a stylus, a finger (i.e. touch) or any conductive object touching the screen. The physical object may be used for pointing, painting, writing (hand writing recognition) and any other activity that is typical for user interaction with a device.

Physical object detection can be used for mouse emulation, graphic applications etc. For example, when a digitizer is capable of detecting two types of user interactions it may be necessary to define which interaction is primary in order to allow convenient use of the available applications.

For example, consider a digitizer system capable of detecting both an electromagnetic (EM) stylus and touch. The interactions of a user are used for mouse emulations, hence the user can control the cursor movements by touching the sensor or by using an EM stylus. A problem arises when the user touches the sensor while using the stylus, or switches between using the stylus and touching the screen. Clearly the cursor should not be in two places at once, nor should it hop from the stylus location to the touch location if the stylus is briefly removed from the sensor plane.

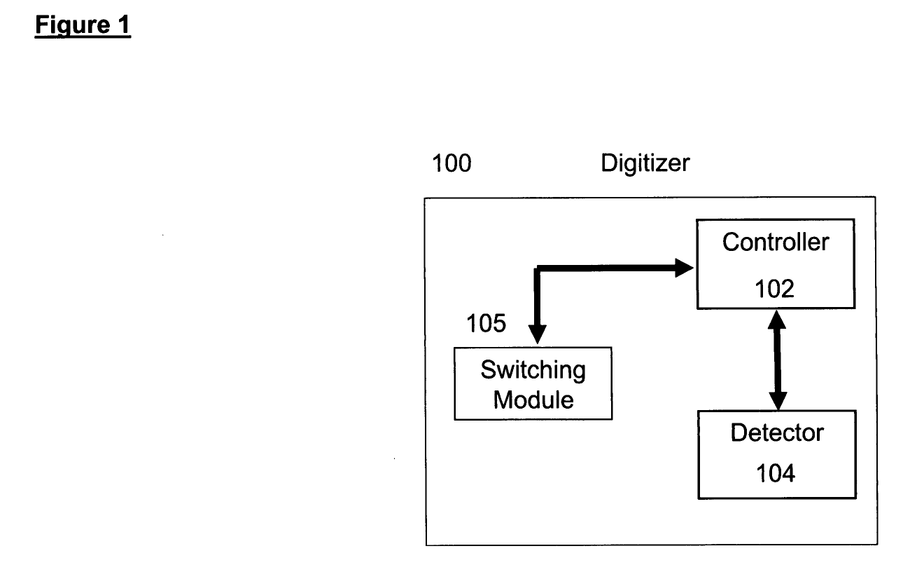

Reference is now made to FIG. 1, which is a block diagram of an apparatus for detection of user interactions, according to a preferred embodiment of the present invention.

Apparatus 100 comprises a controller 102, connected to a detector 104.

The controller 102 is configured for setting a detection mode for each user interaction, according to a predetermined policy, using a switching module 105. An exemplary switching logic is introduced using state-machine flow charts below.

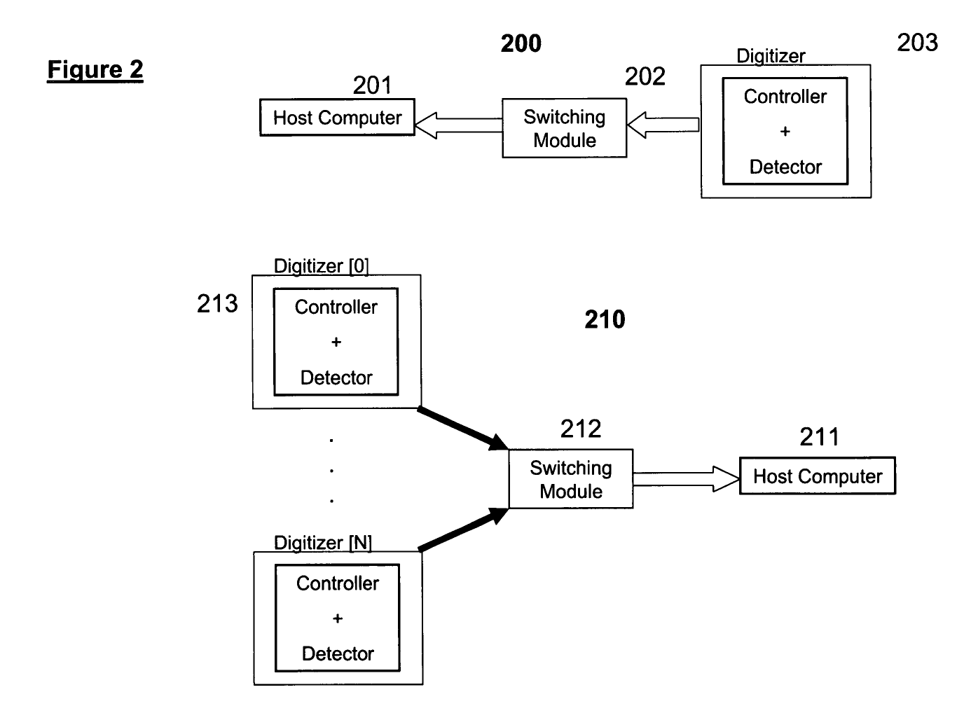

Reference is now made to FIG. 2 which is a block diagram of systems according to preferred embodiments of the present invention.

In one system 200, the switching module is implemented on an independent switching unit 202, placed between the digitizer 203 and a host computer 201. The switching module receives information regarding user interactions from the digitizer 203, switches between the received user interactions and sends the appropriate information to the host computer 201.

With system 210, several digitizers 213 are connected to a switching module 212. In this system, the switching module 212 selects the detection information to be transferred to the host 211 according to a specific switching policy.

In some preferred embodiments the switching module could be an integrated part of a first digitizer 213 while the other digitizers are connected to the first digitizer 213 as slaves.

In a preferred embodiment, the illustrated apparatus or system may switch among detection modes of one or more user interactions, according to a switching logic described using state-machine flow charts below. Such state-machine logic uses a set of predefined detection modes for each user interaction, and a policy comprising a set of rules for switching between the detection modes. The controller 102 applies a detection mode for each user interaction.

Preferably, the detection modes and rules are defined in accordance with a predetermined policy in relation to the user-interactions. Optionally, such a policy may include granting one-user interaction a defined priority over another user interaction.

In a preferred embodiment, the controller 102 may consider one user interaction as the primary and the other user interaction as the secondary user interaction.

In this embodiment, the algorithm always chooses the primary signal over the secondary signal. When the input signals originate from the presence of physical objects at the proximity of the sensor plane, the algorithm always chooses the primary object position coordinates over the secondary object position coordinates. When the primary object is not present, the algorithm may choose the secondary object position coordinates.

The policy may be a dynamically changing policy. The policy may include granting priority according to a dynamically changing parameter. For example, the preference policy may include granting priority to any new input user interaction over a previously input user-interaction received before the new input user interaction.

In a preferred embodiment of the present invention, a stylus is detected by dynamically switching among a predetermined set of detection modes for a stylus. The set may include, but is not limited to: stylus search—searching for an indication for a stylus presence, stylus tracking—tracking the stylus exact position, and using it as an indication for mouse emulation, or any other relevant application, or stylus-exist comprising approximate sensing of stylus location.

For example, when the stylus is hovering a certain distance above a detector 104 comprising several sensing elements, higher than the critical height for accurately detecting the stylus position, the sensing elements can detect the presence of the stylus but can not calculate the accurate position coordinates of the stylus. In this case, the controller 102 sets a stylus-exist detection mode for this stylus.

In another example, hand held stylus signals are transferred to the apparatus 100 through the hand of the user. The hand may be susceptible to various signals from the environment, thus the stylus signals can be used as indication that the stylus exists in the whereabouts of the sensor, but the exact position of the stylus cannot be accurately determined. In this case also, the controller 102 sets a stylus-exist detection mode for this stylus.

In a preferred embodiment, a touch user interaction may be detected in one of the following detection modes: Finger searching—finding an indication of a user touch, finger tracking—finding the exact location of the touch and using the touch position as an indication for mouse emulation or any other relevant application, or waiting—keeping track of the touch position, without using the position as an indication for any application.

In a preferred embodiment, the controller 102 may switch between detection modes, in accordance with switching logic, as described using state-machine charts, in the following examples. The switching logic is implemented in the switching module 102.

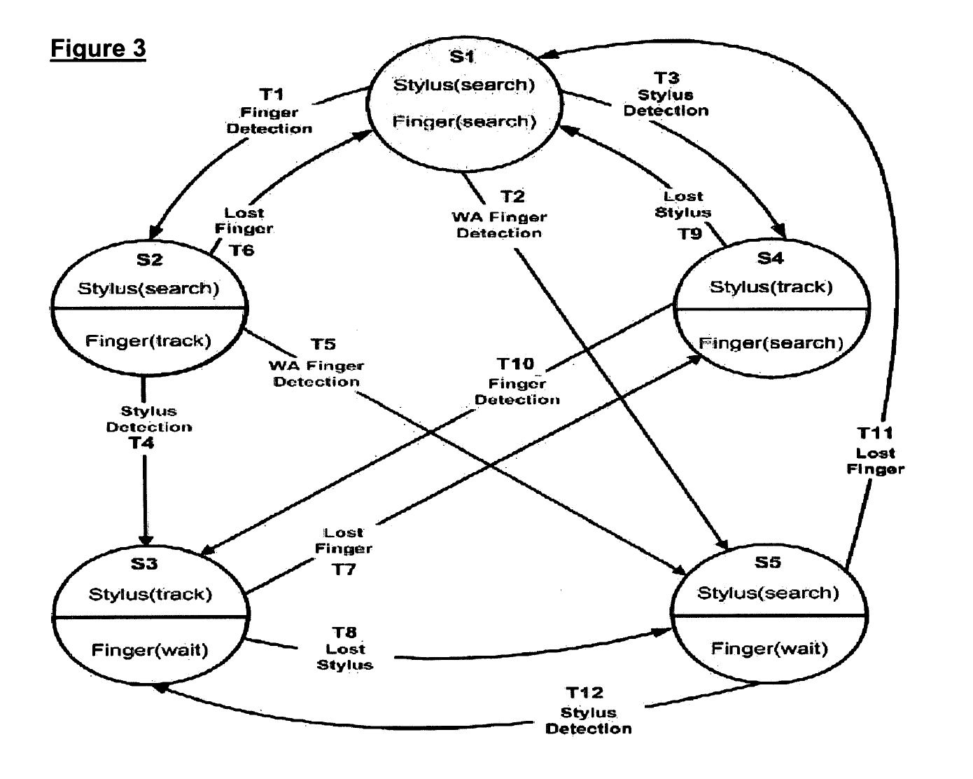

Reference is now made to FIG. 3 which is a flow diagram of a first state machine, illustrating logic for detection mode switching, according to a preferred embodiment of the present invention.

This exemplary first state-machine illustrated logic is used to control the switching of detection modes of stylus and touch user-interactions. In this example, the stylus positioning is considered as a primary user interaction and the touch as a secondary user interaction. Hence, when both interactions occur simultaneously, the controller 102 always prefers the stylus coordinates over touch coordinates.

Other embodiments may implement a similar switching logic that considers touch as the primary interaction and stylus positioning as secondary one.

Some embodiments may use the state machine described in FIG. 3 for controlling the detection mode switching in relation to a couple of user interactions. However, this first state-machine may be easily extended to include switching among detection modes relating to several respective objects.

Upon start-up the state-machine is in S1. The system remains in S1 as long as no user interaction is detected at the surface of the detector 104. In S1 the controller sets a search mode for both stylus and touch user interactions.

In a preferred embodiment, a touch is identified when the user applies a finger to create a localized affect on a sensor plane. The user touch is considered localized when the touch affects a limited number of sensing elements (i.e. the touch affects a small area on the sensor surface). In this case any touch event that affects a wide area on the sensor surface is ignored.

In S1, if a localized touch is detected T1, the state-machine switches to S2, and if a stylus signal is detected T3, the state-machine switches to S4.

In S2, the controller 102 sets a finger tracking detection mode for touch, while applying a stylus-search detection mode for the stylus. In one example, the touch coordinates are used as an indication for a computer program. Meanwhile, the detector keeps searching for stylus signals. Upon detection of a stylus signal T4, the state-machine switches to S3. Still in S2, if touch disappears, for example, when the finger is removed from the sensor, the state-machine switches back to S1.

The state-machine is in S3 as long as both touch and stylus are detected simultaneously. In this state the stylus position is used as an indication for any relevant application running on the computing device and the touch coordinates are ignored. When touch is no longer detected, for example when a finger is removed from the sensor T7 the state machine switches to S4. When the stylus is removed or when the stylus is lost track of, the state-machine switches from S3 to S5.

In S4 stylus signals are detected and there is no indication of touch. As a result, the detector sets stylus-tracking detection mode and touch-searching detection mode, to the stylus and the touch respectively. If the stylus is removed or lost track of T9, the state-machine switches to S1. Upon detection of touch T10, the state-machine switches from S4 to S3.

The state-machine switches to S5 when there is a wide area touch indication that a present policy deems to be ignored while searching for stylus signals, or when the state-machine is in S3 and the stylus is lost track of.

In S5, if the touch disappears or a finger is removed from the sensors T11, the state-machine switches to S1, and if the stylus is detected T12, the state-machine switches to S3.

In a preferred embodiment of the present invention, there is a difference between cases when the touch is the first user-interaction to be detected and cases when the touch is detected after the stylus was detected.

This difference relies on an assumption that the user may remove the stylus momentarily without intending to shift control of the application to the finger touch, and that if the user indeed means to switch to touch control he/she removes the finger from the sensor and then touches the sensor again at the desired location.

This difference is also desirable in applications where the stylus can change its frequency according to its status (i.e. hovering vs. contacting the sensor surface etc.).

For example, consider a stylus which is hovering over the sensor while the user touches the sensor. The user is attempting to move the mouse cursor to a desired icon on the display screen and click the icon. In this case the state-machine is in S3 which defines stylus-tracking and finger-waiting detection modes. Thus, the stylus coordinates are used to locate the mouse cursor and touch coordinates are tracked but are not used as an indication for any relevant application.

When the stylus touches the sensor its frequency may changed, causing the detector to lose track of it. However, in this case the stylus is still present at the sensor surface and the controller 102 switches to a search detection mode for the stylus, to establish the stylus new frequency.

If the state-machine switches to S2, the touch coordinates are used to relocate the mouse cursor. By the time the apparatus 100 identifies the new frequency of the stylus and shifts the control back to the stylus, the cursor is no longer at the desired location. However, when the state-machine switches from S3 to S5, the touch coordinates are ignored and the mouse cursor remains in its place until the stylus signals are once again detected.

A preferred embodiment of the present invention incorporates a palm rejection method, i.e. ignoring the touch signals in cases where the user is placing his\her palm or hand over the screen. The necessity of palm rejection arises from the convenience of placing the hand of a user over the sensor while using the stylus and not intending this type of touch to be interpreted as a user interaction.

A preferred embodiment implements palm rejection by distinguishing between localized touch events and wide area touch events. Wide area touch events occur when touch signals are received on more then a predetermined number of consecutive antennas or sensors. Other embodiments may utilize other methods in order to implement palm rejection.

In order to clarify how palm rejection is incorporated into the preferred embodiment, we now refer back to FIG. 3. When this first state machine defines search detection modes for both stylus and touch signals, in S1, and a wide area touch event occurs T2, the state-machine switches to S5, where the touch signals are ignored and the detector continues its search for the stylus signals.

Another transition T5 to control-state S5 occurs when a wide area touch event is detected while the state machine is in S2, where the detector is tracking localized touch/finger signals.

Other embodiments of the present invention may not utilize palm rejection. In cases where any type of touch is regarded as a legitimate touch event the state-machine switches from S1 to S2 whenever the detector identifies touch signals. In these other embodiments, Transitions T5 and T2 do not exist.

In another embodiment of the present invention, this first state-machine logic may be modified to ignore touch signals when the stylus is detected in the proximity of the sensor even if accurate stylus detection is impossible. This detection mode is referred to above as the exist-level mode.

In order to disable the touch signals whenever the stylus is in the whereabouts of the sensors, a couple of modifications are added to the first state machine described logic in FIG. 3. The state-machine switches from S2 to S5, not only when a wide area touch is detected, but also when the existence of a stylus is sensed. In addition, the state-machine switches from S1 to S5 if a touch event and stylus existence are detected at the same time or in the event of wide area touch detection.

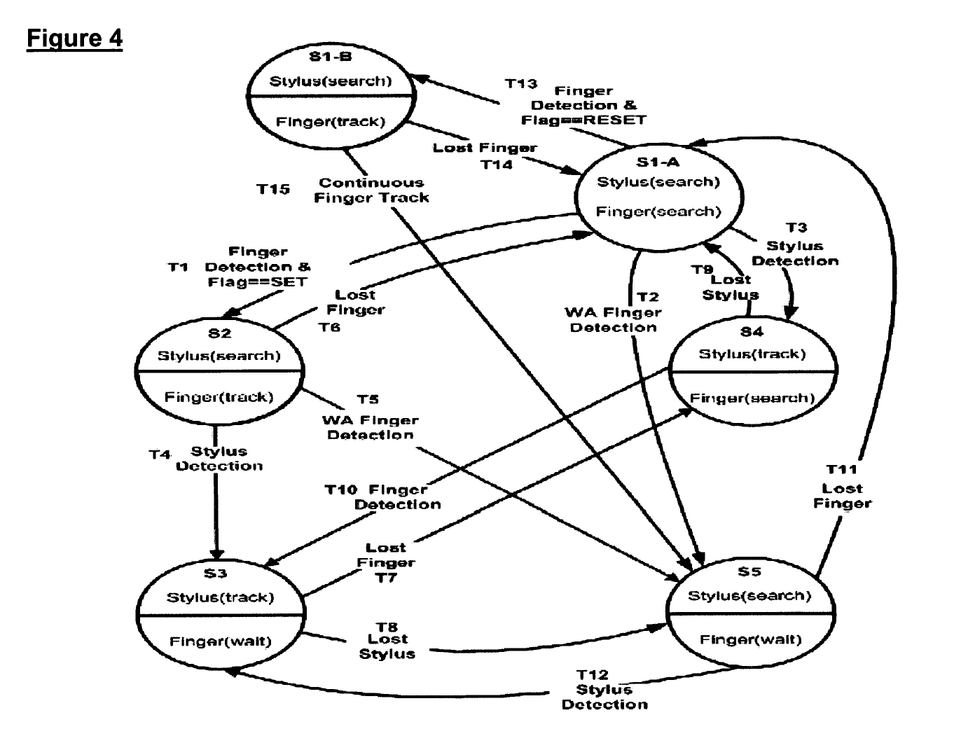

Reference is now made to FIG. 4 which is a flow diagram of a second state machine, illustrating logic for detection mode switching, according to a preferred embodiment of the present invention.

FIG. 4 illustrates a state machine, as described earlier (in FIG. 3), having an additional state (S1-B) implementing touch-gesture recognition.

A preferred embodiment of the present invention defines a dedicated touch gesture to be utilized as an indication for switching between detection modes.

For example, a predefined touch gesture may be used, when detected, as an indication for switching between two detection modes of a stylus.

In another example, an interaction via a stylus is considered as a primary interaction and touch as a secondary interaction. Usually, when the stylus is present in the proximity of the sensor, either in the stylus-tracking detection mode or in the stylus-exist detection mode, touch interactions are ignored. Once the user performs the dedicated touch gesture, as a way of indicating his\her desire to utilize touch signals instead of the stylus, the digitizer ignores the stylus interactions until the user performs a dedicated touch gesture as an indication of his desire to switch back to the stylus interaction. In other embodiments the dedicated gesture may grant priority to the touch as long as the stylus is not detected. In this case the stylus should be removed before performing the dedicated gesture, i.e. the system is either in S1 or S5. These examples eliminate the risk of utilizing accidental touch events when the stylus is removed from the sensor.

One such touch gesture is the tap gesture. A preferred embodiment may use a ‘tap’ gesture to enable the utilization of touch coordinates as an indication for the relevant application. When the user intends to use touch signals he\she taps the sensor. Once the ‘tap’ gesture is recognized, the touch signals that follow are used as indications for the relevant applications. In the preferred embodiment the dedicated gesture is a touch gesture and touch signals are utilized as long as the stylus is not in the proximity of the sensor. In other embodiments, the dedicated gesture can be performed by either touch or stylus and can have different interpretations according to the type of user interaction performing the gesture.

A ‘tap’ gesture may be defined as a light touch, which means that the user is touching the sensor for a short period of time. Other embodiments may utilize other gestures, for example, a ‘double-click’ gesture, or a gesture involving drawing a certain shape such as a circle, a line or an X. In addition, the direction of the movement may also be taken into consideration, for example, drawing a line from the left to right may be considered as a gesture that grants priority to the stylus while drawing a line from right to left may be utilized to grant priority to touch.

In a preferred embodiment a touch gesture is used to enable touch signals. Other embodiments may utilize a stylus gesture in order to enable touch signals and vice versa.

A preferred embodiment of the present invention utilizes a flag signal that is SET once a ‘tap’ gesture is recognized and RESET once a stylus is detected. Upon start-up the state-machine is in S1-A. The state machine remains in S1-A, as long as there are no physical objects present at the sensor surface. In S1-A the detection mode defines a stylus-searching level as well as a finger-searching level.

Once touch signals are detected and the flag signal is RESET T13, the state-machine switches to S1-B. In this state the nature of the touch event is examined. If touch signals are detected for a prolonged duration of time T15, the state-machine switches to S5, hence the touch signals are ignored, and the flag remains RESET. If the touch event occurs for a short period of time T14 (i.e. the touch event resembles a ‘tap’ gesture), the state-machine switches back to S1-A, and the flag signal is SET. From this point onward, the state-machine switches to S2, upon detection of additional touch signals T1.

The state machine, as illustrate in FIG. 4, is designed to recognize a tap gesture.

Some embodiments may alter this state machine illustrated logic to recognize other gestures.

Some embodiments may use two gestures, one for enabling touch signals and another for enabling stylus signals. The latter approach may enable dynamic priority according to the last received gesture. For example, a tap gesture in the touch frequency may grant high priority to the touch signals and stylus signals are ignored until a corresponding gesture is detected in the stylus frequency.

This second state-machine may be easily extended to switch between input signals relating to several respective objects.

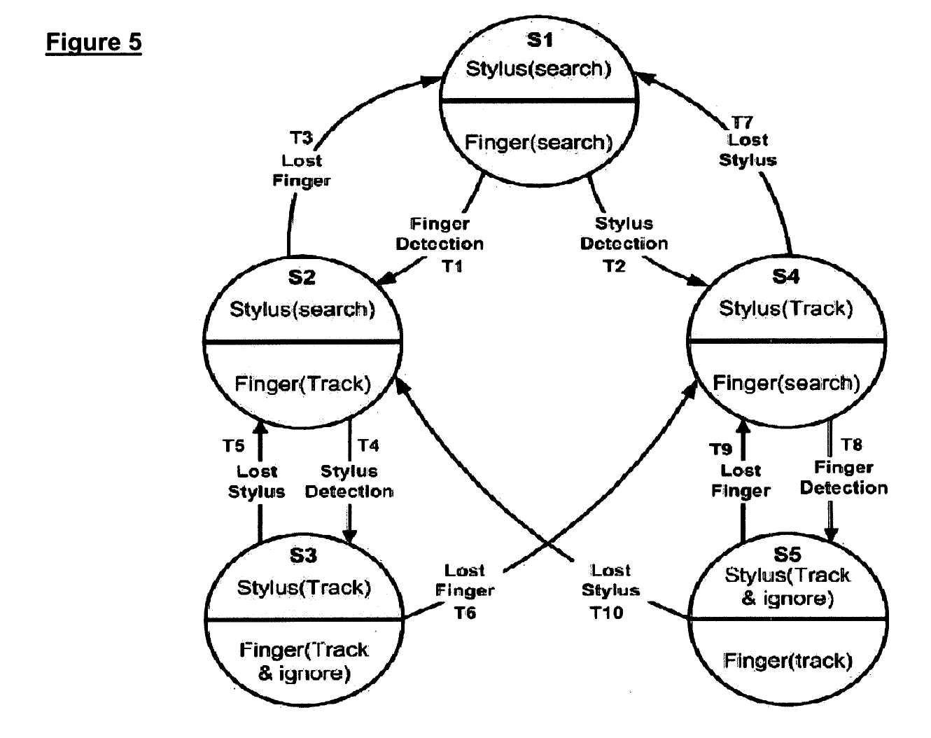

Reference is now made to FIG. 5 which is a flow diagram of a third state machine, illustrating logic for detection mode switching, according to a preferred embodiment of the present invention.

In this preferred embodiment of the present invention, a detection mode policy implements a dynamically changing user-interaction preference. This policy defines a dynamic priority decision.

This exemplary third state machine logic is defined to control the switching of detection modes, relating to stylus and finger user-interactions. However, this third state-machine may be easily extended to switch between detection modes for several input signals, relating to various respective detected objects.

In this embodiment the newly received user-interaction is given priority over existing user-interactions.

Upon start up the state-machine is in S1, which defines a finger-searching detection mode and a stylus-searching detection mode. From S1, the state machine may switch to either S2 or S4.

When touch signals are detected T1, this third state machine switches to control-state S2, which defines the finger-tracking as the detection mode for touch interactions and the stylus-searching as the detection mode for stylus interactions. If the user removes his\her finger from the sensor and the touch signal is lost T3, the state-machine switches back to S1.

When stylus signals are detected T2, the state-machine switches to from S1 to S4 which defines the stylus-tracking as the detection mode for stylus signals and the finger-searching as the detection mode for touch signals. If the user removes the stylus and the stylus signals are no longer detected T7, the state-machine switches back to S1.

When the state-machine is in S2, the detection mode is set to define finger-tracking and stylus-searching detection modes. Since there is only one detected user interaction, the touch coordinates are used as an indication for any relevant application. Now, if stylus signals are detected T4, the state-machine switches to S3, and if the user removes his\her finger from the sensor T3, the state-machine switches back to S1.

In S3, the stylus signals are tracked along with the touch signals. In this state the stylus coordinates are used as an indication for any relevant application (i.e. stylus-tracking mode) and the finger coordinates are ignored, though being kept track of (i.e. waiting detection mode).

In S3 the state-machine may switch to one of the following: If the stylus is removed T5, the state-machine switches back to S2. If the touch signals are no longer detected T6 the system switches to S4.

When the state-machine is in S4, the stylus signals are the only input signals present, and the stylus position is the only indication for any relevant application. Nevertheless, the detector 104 searches for touch signals. In S4, when touch interactions are detected T8, the state-machine switches to S5, and when the stylus is removed T7, the state-machine switches to S1.

In S5 the touch user-interactions are given priority over the stylus user-interactions. Thus the touch coordinates are utilized and the stylus coordinates are ignored. However, the digitizer keeps tracking the stylus position and once the touch is removed T9, the state-machine switches back to S4. When the stylus is removed T10, the state-machine switches to S2.

As described above, this preferred embodiment gives priority to the newest interaction detected. When the detector uses the stylus coordinates and a new touch event occurs, the detector starts using the touch coordinates. It continues to do so as long as both touch and stylus signals are detected.

With this embodiment, in order to shift control back to the stylus the stylus has to be considered a newer interaction than the touch interaction. This situation can be created by removing the stylus from the sensor and then bringing it back to the sensor plane. This kind of maneuvering causes the stylus signals to be recognized as the newer signals, hence the stylus coordinates are then taken as an indication for applications, and the touch coordinates are ignored.

A preferred embodiment of the present invention utilizes a digitizer capable of detecting several user interactions simultaneously. Other embodiment may involve several digitizers, each capable of detecting a specific type of user interaction.

Using one digitizer capable of detecting several user interactions are may prove advantageous with the following examples.

In a system wherein a first digitizer is capable of sensing an electromagnetic stylus and a second digitizer is capable of detecting touch, the touch sensitive digitizer is completely oblivious of signals originating the electromagnetic stylus and vice versa. Therefore, any signals from the electromagnetic stylus affecting the hand is not detected by the touch sensitive digitizer. In other words, the stylus existence cannot be sensed through the touch sensitive digitizer nor would it be possible to implement a switching policy depending on the stylus exist detection mode. In fact, any system designed to detect a specific user interaction while being oblivious of other user interactions will suffer the same limitation. Therefore, the later example is applicable for any set of digitizers designed to sense different user interactions.

Another scenario where a single digitizer is preferable to a set of digitizers is the scenario illustrated in FIG. 5. The switching policy is defined to grant priority to the newest object in the system. When all the objects in the system are detected through a single digitizer, the detection order is well defined. However, a system comprising several digitizers must synchronize the different digitizer units in order to implement the switching policy. This is not a simple task considering the fact that each digitizer may operate at a different rate.

By using a single digitizer capable of detecting several user interactions, we avoiding timing issues, ambiguity regarding detection order, inability to sense the signals relating to one user interactions through another user interaction etc.

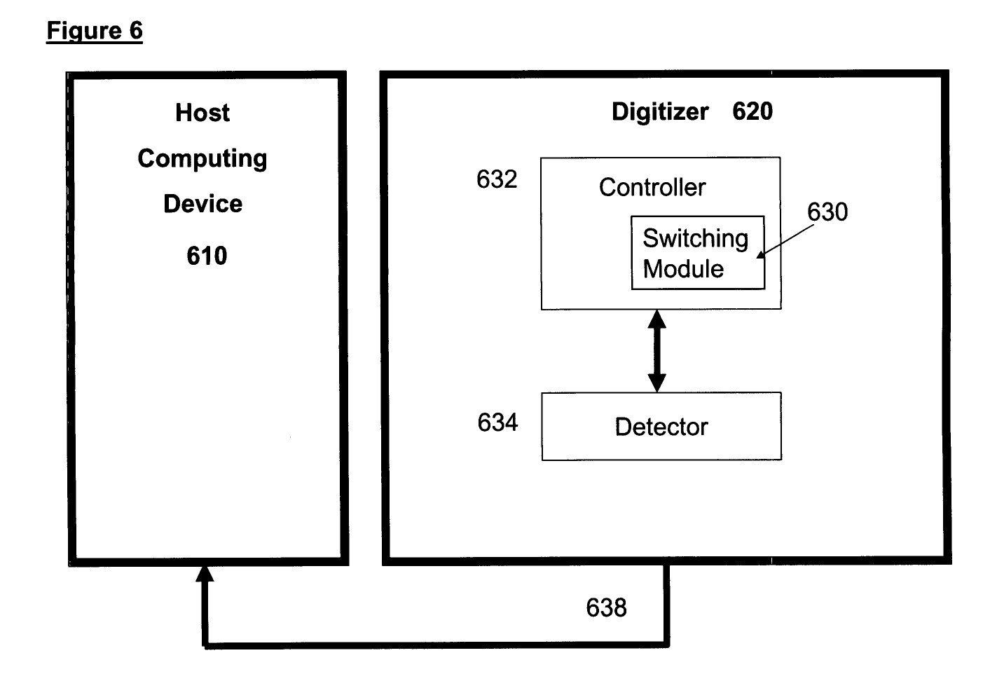

Reference is now made to FIG. 6, which is a block diagram illustrating a first system for detecting user interactions, according to a preferred embodiment of the present invention.

The first system comprises: a host computing device 610, for running computer applications, a digitizer 620 for inputting multiple user interactions, associated with the host computing device 610, and configured to provide the host computing device 610 with input data relating to user interactions, and a switching module 630, implemented on the digitizer 620, for switching between detection modes for each user-interaction.

The switching module 630 is implemented as a part of the controller 632, for setting a detection mode for each user interaction, according to a predetermined policy, using a switching logic, as illustrated in the state-machine charts above.

The digitizer module 620 further comprises a detector 634, associated with the controller 632, for detecting an input user-interaction according to a detection mode set for each user interaction, and an output port 638, associated with the detector 634, for providing the host computing device 610 with relevant user interaction detection data.

The controller 632 reads the sampled data, processes it, and determines the position of the physical objects, such as stylus or finger. The switching module 630, may be implemented on the digitizer 620, using either a digital signal processing (DSP) core or a processor. The switching module 630 may also be embedded in an application specific integrated circuit (ASIC) component, FPGA or other appropriate HW components. The calculated position coordinates are sent to the host computing device 610 via a link, as illustrated in U.S. patent application Ser. No. 10/649,708, under the heading “Digital unit”.

Embodiments of the present invention may be applied to a non-mobile device such as a desktop PC, a computer workstation etc.

In a preferred embodiment, the computing device 610 is a mobile computing device. Optionally, the mobile computing device has a flat panel display (FPD) screen. The mobile computing device may be any device that enables interactions between the user and the device. Examples of such devices are—Tablet PCs, pen enabled lap-top computers, PDAs or any hand held devices such as palm pilots and mobile phones. In a preferred embodiment, the mobile device is an independent computer system having its own CPU. In other embodiments the mobile device may be only a part of a system, such as a wireless mobile screen for a Personal Computer.

In a preferred embodiment, the digitizer 620 is a computer associated input device capable of tracking user interactions. In most cases the digitizer 620 is associated with a display screen to enable touch or stylus detection. Optionally, the digitizer 620 is placed on top of the display screen. For example, U.S. Pat. No. 6,690,156 “Physical Object Location Apparatus and Method and a Platform using the same” (Assigned to N-trig Ltd.) and U.S. patent application Ser. No. 10/649,708 “Transparent Digitizer” (filed for N-trig Ltd.), hereby incorporated by reference, describe a positioning device capable of detecting multiple physical objects, preferably styluses, located on top of a flat screen display.

Optionally, the digitizer 620 is a transparent digitizer for a mobile computing device 510, implemented using a transparent sensor.

In the preferred embodiment of the present invention, the transparent sensor is a grid of conductive lines made of conductive materials, such as indium tin oxide (ITO) or conductive polymers, patterned on a transparent foil or substrate, as illustrated in U.S. patent application Ser. No. 10/649,708, referenced above, under “Sensor”.

In this preferred embodiment of the present invention a front end is the first stage where sensor signals are processed. Differential amplifiers amplify the signals and forward them to a switch, which selects the inputs to be further processed. The selected signals are amplified and filtered by a filter and amplifier prior to sampling. The signals are then sampled by an analog-to-digital converter (A2D) and sent to a digital unit via a serial buffer, as illustrated in U.S. patent application Ser. No. 10/649,708, referenced above, under “Front end”.

In a preferred embodiment of the present invention, a front-end interface receives serial inputs of sampled signals from the various front-ends and packs them into parallel representation.

In a preferred embodiment, the digitizer 620 sends the host computing device 610 one set of coordinates and a status signal indicates the presence of the physical object at a time.

The digitizer 620 has to make the decision which coordinates to send to the host computing device 610 when more then one object is present. The decision is made utilizing the switching module 630, which may be implemented on the digitizer 620.

In a preferred embodiment, the switching module 630 implements a switching logic, for switching among detection modes. In one embodiment, the switching logic is defined in accordance with a predetermined policy in relation the user interactions.

Optionally, this preference policy may include granting one type of user interaction a definite priority over another type of user interaction.

Alternatively, this policy may be a dynamically changing policy which may include granting priority according to a dynamically changing parameter. For example, the preference policy may include granting priority to any new input user interaction over a previously input user interaction, received before the new input user interaction.

Examples for a switching logic are provided above, using state-machine flow charts, in FIGS. 3-5.

In a preferred embodiment, the digitizer 620 is integrated into the host computing device 610 on top of a flat panel display (FPD) screen. In other embodiments the transparent digitizer can be provided as an accessory that could be placed on top of a screen. Such a configuration can be very useful for laptop computers, which are already in the market in very large numbers, turning a laptop into a computing device that supports hand writing, painting, or any other operation enabled by the transparent digitizer.

The digitizer 620 may also be a non-transparent digitizer, implemented using non-transparent sensors. One example for such embodiment is a Write Pad device, which is a thin digitizer that is placed below normal paper. In this example, a stylus combines real ink with electromagnetic functionality. The user writes on the normal paper and the input is processed on the digitizer 620, utilizing the switching module 630 implemented thereon, and simultaneously transferred to a host computing device 610, to store or analyze the data.

Another embodiment using a non-transparent digitizer 620 is an electronic entertainment board. The digitizer 620, in this example, is mounted below the graphic image of the board, and detects the position and identity of gaming figures that are placed on top of the board. The graphic image in this case is static, but it may be manually replaced from time to time (such as when switching to a different game).

For example, a digitizer associated with a host computer can be utilized as gaming board. The gaming board may be associated with several distinguishable gaming pieces, such as electromagnetic tokens or capacitive gaming pieces with unique characteristics. In this application there could be a situation where more then one gaming piece is sensed by the digitizer. At any given time during a game, a decision has to be made regarding which gaming piece should be given priority. The policy by which the gaming pieces, i.e. user interactions, are handled may be dynamically configured by the relevant application running on the host computer.

In some embodiments of the present invention a non-transparent digitizer is integrated in the back of a FPD screen. One example for such an embodiment is an electronic entertainment device with a FPD display. The device may be used for gaming, in which the digitizer detects the position and identity of gaming figures. It may also be used for painting and/or writing in which the digitizer detects one or more styluses. In most cases, a configuration of a non-transparent digitizer with a FPD screen is used when high performance is not critical for the application.

The digitizer 620 may detect multiple finger touches. The digitizer 620 may detect several electromagnetic objects, either separately or simultaneously. Furthermore, the touch detection may be implemented simultaneously with stylus detection. Other embodiments of the present invention may be used for supporting more than one object operating simultaneously on the same screen. Such a configuration is very useful for entertainment application where few users can paint or write to the same paper-like screen.

In a preferred embodiment of the present invention, the digitizer 620 may detect simultaneous and separate inputs from an electromagnetic stylus and a user finger. However, in other embodiments the digitizer 620 may be capable of detecting only electromagnetic styluses or only finger touches.

For embodiments of dual detection digitizers the reader is referred to the above referenced U.S. Pat. No. 6,690,156 patent and Ser. No. 10/649,708 patent application. However, the embodiment of the invention may be implemented in any system that receives two or more types of user interactions.

In a preferred embodiment of the present invention, if a physical object in use is a stylus, the digitizer 620 supports full mouse emulation. As long as the stylus hovers above the screen, a mouse cursor follows the stylus position. Touching the screen stands for left click and a dedicated switch located on the stylus emulates right click operation.

In a preferred embodiment of the present invention, a detected physical object may be a passive electromagnetic stylus. External excitation coils may surround the sensors of a digitizer and energize the stylus. However, other embodiments may include an active stylus, battery operated or wire connected, which does not require external excitation circuitry. In a preferred embodiment, the electromagnetic object responding to the excitation is a stylus. However, other embodiments may include other physical objects comprising a resonant circuit or active oscillators, such as gaming pieces, as known in the art.

In a preferred embodiment, a digitizer supports full mouse emulation, using a stylus. However, in different embodiments a stylus is used for additional functionality such as an eraser, change of color, etc. In other embodiments a stylus is pressure sensitive and changes its frequency or changes other signal characteristics in response to user pressure.

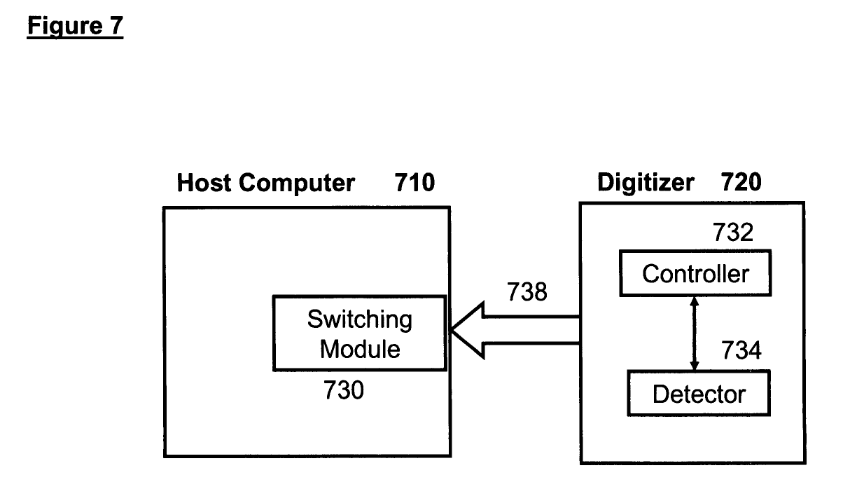

Reference is now made to FIG. 7 which is a block diagram, illustrating a second system for detecting a plurality of user interactions, according to a preferred embodiment of the present invention.

The second system is similar to the first system, presented in FIG. 6.

However, with in the second system, the switching module is implemented on the host computer 710 rather than on a digitizer.

Thus the second system comprises: a host computing device 710, for running computer applications, a digitizer 720, for detecting user-interactions, associated with the host computing device 710 and configured to provide the host computing device 710 with input data relating to multiple user interactions and a switching module 730, implemented on the host computing device 710, for switching between the user interactions.

The switching module 730 dynamically sets and updates a detection mode for each of the user interactions according to a specific policy. The digitizer comprises: a controller 732 for processing information received by the detector, a detector 734, associated with the controller 732, for detecting input user interactions according to the set detection modes, and an output-port 738 for providing the host computing device 710 with relevant user-interaction detection data.

In this preferred embodiment of the present invention the digitizer 720, technically described above, sends several sets of coordinates and status signals to the host computing device 710. The coordinates and signals are then processed on the host computing device 710, by the switching module 730, implemented on the host computer device 710.

The switching module 730, as described above, implements a switching logic as described using state machine charts above, in FIGS. 3, 4 and 5.

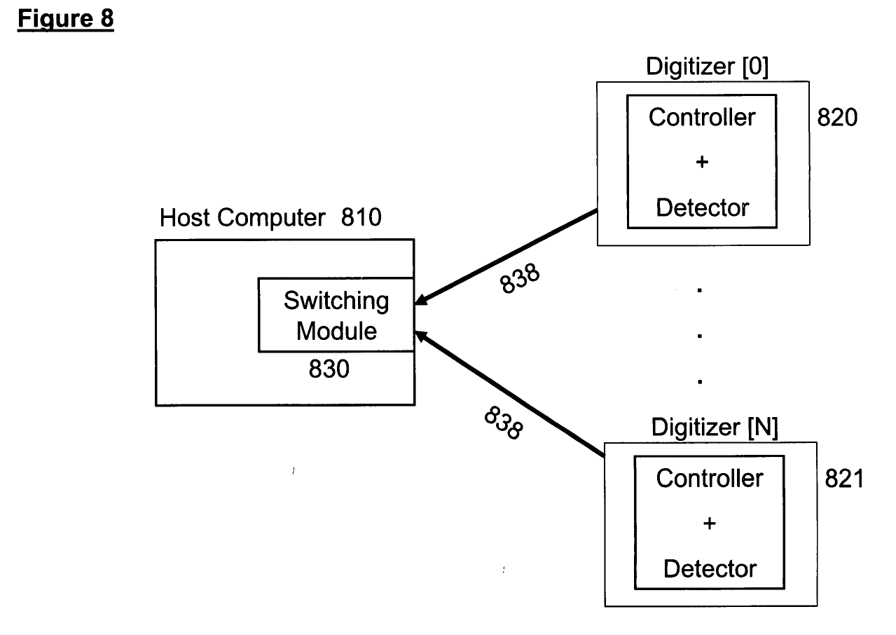

Reference is now made to FIG. 8, which is a block diagram, illustrating a third system for detecting a plurality of user-interactions, according to a preferred embodiment of the present invention.

The third system comprises: an host computing device 810, for running computer applications, several digitizers 820-821, for inputting user-interactions, associated with the host computing device 810, each one of the digitizers 820-821, being configured to provide the host computing device 810 with input data relating to user interactions, and a switching module 830, implemented on the host computing device 810, for arbitrating between said user interactions.

Each digitizer 820-821 comprises: a controller 832, for processing the information retrieved from the detector, a detector 834, associated with the controller 832, for detecting an input user-interaction, and output-ports 838, associated with the digitizers 820-821, for providing the host computing device 810 with relevant user interaction detection data.

In one preferred embodiment of the present invention each of the digitizers 820-821, which are technically described above, senses a different type of user interaction, and sends a respective set of coordinates and status signal to the host computing device 810 for each user interaction. The coordinates and signals are then processed on the host computing device 810, by the switching module 830, implemented on the host computer device 810.

The switching module 830, as described above, implements a switching logic as described above, using state-machine flow charts, provided in FIGS. 3-5.

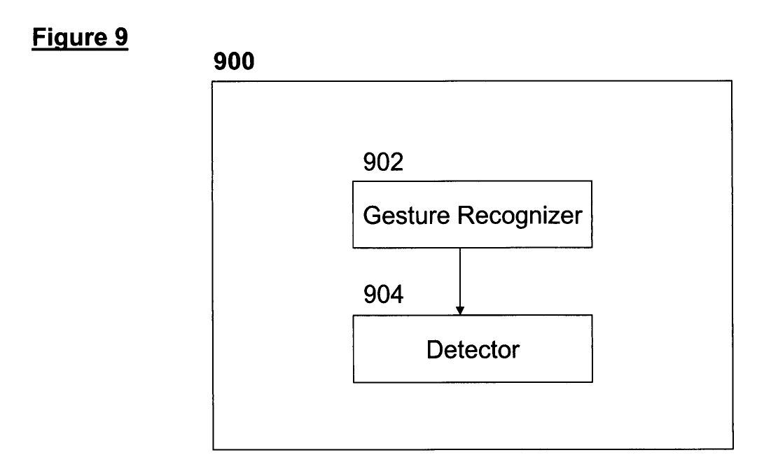

Reference is now made to FIG. 9, which is block diagram of an apparatus for gesture recognition, according to a preferred embodiment of the present invention.

In a preferred embodiment, apparatus 900 comprise a detector 904, for inputting user interaction. These user interactions may comprise various gestures, such as a tap, a double click, and drawing a shape such as a line or a circle. The gesture may also be defined with respect to a direction, for example: drawing a line from right to left.

The apparatus 900 further comprises a gesture recognizer 902, for determining if an input user interaction is a dedicated gesture as described. The gesture recognizer 902 is provided with the necessary logic for recognizing a gesture, as illustrated above, in FIG. 4.

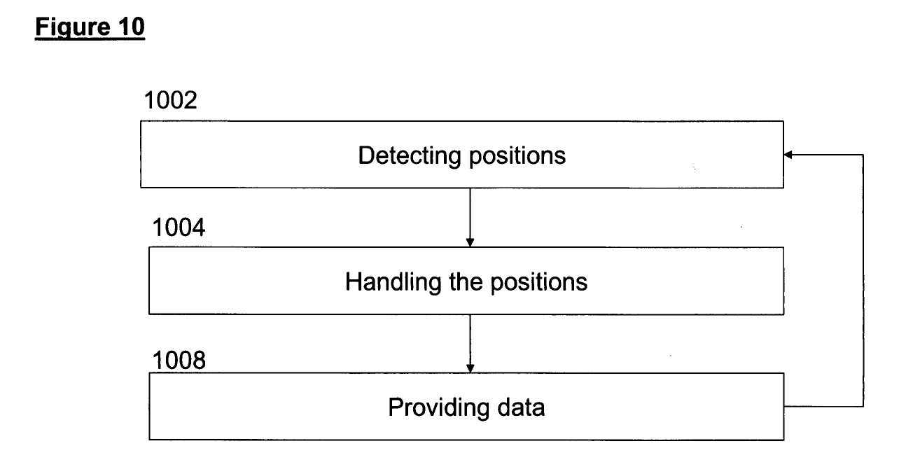

Reference is now made to FIG. 10, which is a flow diagram, illustrating a method for detecting a plurality of user interactions, according to a preferred embodiment of the present invention.

In a preferred embodiment of the present invention, the method comprises detecting positions of the user interactions 1002. Preferably, a detection mode is set for each user interaction and is dynamically updated. For example, a stylus tracking detection mode may be set to define the tracking mode of a stylus as long as the stylus remains in proximity to a digitizer, which tracks the movements of the stylus, but as the stylus is removed, the detection mode is updated and set to stylus-search mode where the location of the stylus is unknown.

Preferably a detection mode set for each of the user interactions, according to a predetermined policy. This policy may set a preference among the various types of user interaction. Such a policy may be a fixed preference policy, for example: giving a touch user interaction a priority over any other user interactions, by discarding any other user interaction while a touch interaction is detected. Alternatively, the policy may be defined to dynamically grant priorities among user interactions, for example, by granting priority to any input user interaction over previously input user interactions.

The method, according to a preferred embodiment, further comprises handling the position of each of the user interactions 1004, in accordance with the detection mode set for the user interaction and the set policy. Based on this handling, data which relates to the detected user interactions can be provided 1008, for example, for a mouse emulation computer program with finger detection information, picked according to the detection mode set for the interaction.

It is expected that during the life of this patent many relevant digitizer systems and devices, capable of detecting multiple physical objects will be developed, and the scope of the terms herein, particularly of the terms “digitizer”, “PDA”, “computer”, “stylus”, “mouse”, and “screen”, is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for detecting a plurality of user interactions, comprising:
at least one detector for sensing said user interactions;
at least one respective controller, associated with each of said at least one detector, for finding positions of said user interactions; and
a switching module, associated with said controller, for handling said user interactions, according to a defined policy.

2. The apparatus of claim 1, wherein said detector comprises a plurality of sensing elements, spread across a sensing area.

3. The apparatus of claim 1, wherein said switching module switches among a plurality of modes for handling said user interactions.

4. The apparatus of claim 1, comprising a plurality of detectors.

5. The apparatus of claim 1, wherein at least one of said user interactions is an interaction via an electromagnetic stylus.

6. The apparatus of claim 1, wherein at least one of said user interactions is touch.

7. The apparatus of claim 1, wherein at least one of said user interactions is performed through a capacitive object.

8. The apparatus of claim 1, wherein said policy is defined according to the position of the user interaction.

9. The apparatus of claim 1, wherein said policy is defined according to the characteristics of the user interactions.

10. The apparatus of claim 1, further associated with a host computing device, wherein an application running on said host computing device is operable for setting said policy.

11. The apparatus of claim 6, configured with a policy to discard a wide area touch.

12. The apparatus of claim 1, being configured for detecting a dedicated gesture.

13. The apparatus of claim 12, being configured to use said detection of said dedicated gesture to set a policy with regard to said detection.

14. The apparatus of claim 12, wherein said policy defines granting predominance to one user interaction over other user interactions.

15. The apparatus of claim 1, configured to select one user interaction for detection whilst disabling detection of a second user interaction.

16. The apparatus of claim 1, wherein the policy includes granting at least one of said user interactions priority over at least one other of said user interactions.

17. The apparatus of claim 1, wherein the policy is a dynamically changing policy.

18. The apparatus of claim 1, wherein the policy includes granting priority to a newest user-interaction over an earlier user interaction.

19. System for detecting a plurality of user-interactions, comprising:
at least one digitizer, configured for detecting at least one user interaction; and
a switching module, associated with said at least one digitizer, for handling data relating to said at least one user interaction.

20. The system of claim 19, further comprising a host computer, associated with said digitizer, wherein said switching module is implemented on said host computer.

21. The system of claim 19, wherein said switching module is implemented on a switching unit.

22. Method for detecting a plurality of user interactions, comprising:
detecting positions relating to each of said user interactions;
handling said positions in accordance with a defined policy; and
providing data relating to said positions.

23. The method of claim 22, wherein said policy is defined according to a dynamically changing parameter.

24. The method of claim 22, wherein at least one of said user interactions is an interaction via an electromagnetic stylus.

25. The method of claim 22, wherein at least one of said user interactions is touch.

26. The method of claim 22, wherein at least one of said user interactions is performed through a capacitive object.

27. The method of claim 22, wherein said policy is configured to discard a wide area touch.

28. The method of claim 22, wherein said method is further configured for detecting at least one dedicated gesture.

29. The method of claim 22, wherein said policy is configurable.

30. The method of claim 22, wherein the policy includes granting at least one of said user interactions priority over at least one other of said user interactions.

31. Apparatus for gesture recognition, comprising:
a detector for detecting at least one user interaction; and
a gesture recognizer, associated with said detector, and configured for determining if said user interaction is a predefined gesture.

32. The apparatus of claim 31, wherein said gesture is a touch gesture.

33. The apparatus of claim 31, wherein said gesture comprises moving an object.

34. The apparatus of claim 33, wherein said gesture comprises moving said object in a specific direction.

35. The apparatus of claim 31, wherein said gesture recognizer is a controller of a digitizer apparatus.

36. The apparatus of claim 31 further configured to trigger switching between control modes, according to said gesture recognition.
